(19) United States
(12) Patent Application Publication
(10) Pub. No.: US 2026/0064792 A1
(43) Pub. Date: Mar. 5, 2026

(54) AUTOMATED CONFIGURATION OF A DIGITAL PLATFORM BASED ON EVALUATION OF DESIGN METRICS

(71) Applicant: Dell Products L.P., Round Rock, TX (US)

(72) Inventors: Shannon Rogers, Austin, TX (US); Paul Somers, Cranberry Township, PA (US); Jordan E. Lord, Austin, TX (US); Max A. Kassler, Cedar Park, TX (US); Eamon Doyle, Ranelagh (IE); Annamarie Huttunen, Littleton, CO (US); Raj Patra, Berhampur (IN)

(21) Appl. No.: 18/820,953

(22) Filed: Aug. 30, 2024

(51) Int. Cl. G06F 16/957; G06F 16/583

(52) U.S. Cl. CPC G06F 16/9577; G06F 16/583

(57) ABSTRACT

An apparatus includes a processing device configured to capture user session information associated with one or more user sessions involving interaction of users with a digital platform and to generate, utilizing the captured user session information, a digital representation of user-perceived content of one or more portions of the digital platform that the users interacted with as part of the one or more user sessions. The at least one processing device is also configured to determine, utilizing the digital representation of the user-perceived content, one or more design evaluation metrics for a design of the one or more portions of the digital platform that the users interacted with as part of the one or more user sessions and to automatically modify a configuration of at least one of the one or more portions of the digital platform based at least in part on the determined design evaluation metrics.

### BACKGROUND

Various organizations develop designs that include a visual stimulus with various information content that an organization is seeking to communicate via that visual stimulus. An organization, for example, may provide users with multiple products (e.g., applications, websites and webpages, etc.) for presenting a given design. It can be difficult, however, to adapt the given design for different computing devices, output formats, for individual differences across viewers of the given design, etc. It is also difficult to quantitatively measure the effectiveness of the given design, such as to ensure that the given design communicates a desired amount and type of information.

### SUMMARY

Illustrative embodiments of the present disclosure provide techniques for automated configuration of a digital platform based on evaluation of design metrics.

In one embodiment, an apparatus comprises at least one processing device comprising a processor coupled to a memory. The at least one processing device is configured to capture user session information associated with one or more user sessions involving interaction of one or more users with a digital platform and to generate, utilizing the captured user session information, a digital representation of user-perceived content of one or more portions of the digital platform that the one or more users interacted with as part of the one or more user sessions. The at least one processing device is also configured to determine, utilizing the digital representation of the user-perceived content, one or more design evaluation metrics for a design of the one or more portions of the digital platform that the one or more users interacted with as part of the one or more user sessions. The at least one processing device is further configured to automatically modify a configuration of at least one of the one or more portions of the digital platform based at least in part on the determined one or more design evaluation metrics.

These and other illustrative embodiments include, without limitation, methods, apparatus, networks, systems and processor-readable storage media.

### BRIEF DESCRIPTION OF THE DRAWINGS

FIG. 1 is a block diagram of an information processing system with functionality for automated configuration of a digital platform based on evaluation of design metrics in an illustrative embodiment.

FIG. 2 is a flow diagram of an exemplary process for automated configuration of a digital platform based on evaluation of design metrics in an illustrative embodiment.

FIGS. 3A-3G show a system configured for digital platform design evaluation in an illustrative embodiment.

FIG. 4 shows an architecture of services for implementing the system of FIGS. 3A-3G in an illustrative embodiment.

FIG. 5 shows a table of cognitive load index, accessibility and readability metric details in an illustrative embodiment.

FIGS. 6A-6E show views of an automated capture of design constructs application in an illustrative embodiment.

FIGS. 7 and 8 show examples of processing platforms that may be utilized to implement at least a portion of an information processing system in illustrative embodiments.

### DETAILED DESCRIPTION

Illustrative embodiments will be described herein with reference to exemplary information processing systems and associated computers, servers, storage devices and other processing devices. It is to be appreciated, however, that embodiments are not restricted to use with the particular illustrative system and device configurations shown. Accordingly, the term “information processing system” as used herein is intended to be broadly construed, so as to encompass, for example, processing systems comprising cloud computing and storage systems, as well as other types of processing systems comprising various combinations of physical and virtual processing resources. An information processing system may therefore comprise, for example, at least one data center or other type of cloud-based system that includes one or more clouds hosting tenants that access cloud resources.

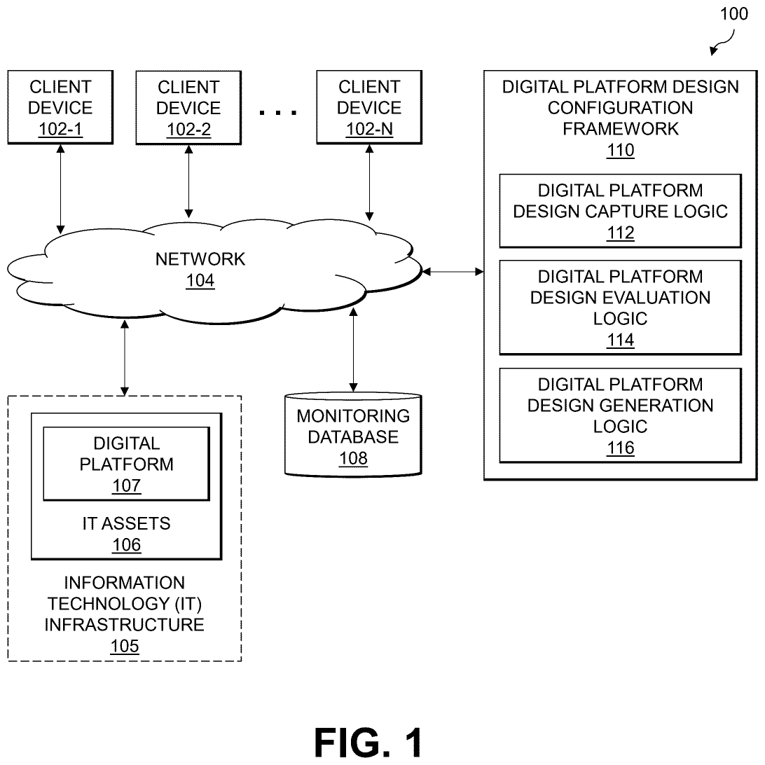

FIG. 1 shows an information processing system 100 configured in accordance with an illustrative embodiment. The information processing system 100 is assumed to be built on at least one processing platform and provides functionality for automated configuration of a digital platform based on evaluation of design metrics. The information processing system 100 includes a set of client devices 102-1, 102-2, . . . 102-N (collectively, client devices 102) which are coupled to a network 104 used to access a digital platform 107 that runs on one or more information technology (IT) assets 106 of an IT infrastructure 105. The digital platform 107 may comprise, for example, a website and/or one or more applications or other interfaces that are accessed by users of the client devices 102 for interacting with a particular enterprise, organization or other entity operating the digital platform 107 (e.g., an e-commerce platform for managing orders and servicing of products and services offered by the enterprise, organization or other entity operating the digital platform 107). The digital platform 107 may rely on various dependent systems (e.g., backend applications running on the IT assets 106 of the IT infrastructure 105) for rendering a user interface (UI) that provides various functionality for performing self-servicing actions related to products and services offered by the enterprise, organization or other entity that operates the digital platform 107. The IT assets 106 of the IT infrastructure 105 may include physical and virtual computing resources. Also coupled to the network 104 is a monitoring database 108 and a digital platform design configuration framework 110.

The digital platform design configuration framework 110 is configured to automate the capture of design constructs associated with the digital platform 107 as users (e.g., of the client devices 102) access the digital platform 107 (e.g., in one or more sessions or other user journeys). The digital platform design configuration framework 110 is therefore able to provide a solution for analyzing and quantifying design constructs of the digital platform 107, and provides a flexible, scalable, validated scaffolding onto which the enterprise, organization or other entity operating the digital platform 107 is able to automate design measures, expand its observational data surveillance, link experiential value to financial profitability or other metrics, identify at-risk users, prioritize online use case opportunities and, ultimately, predict or generate designs which improve the digital platform 107. To do so, the digital platform design configuration framework 110 implements digital platform design capture logic 112, digital platform design evaluation logic 114, and digital platform design generation logic 116. The digital platform design capture logic 112 is configured to capture user session information associated with one or more user sessions involving interaction of one or more users (e.g., of the client devices 102) with the digital platform 107. The digital platform design evaluation logic 114 is configured to generate, utilizing the captured user session information, a digital representation of user-perceived content of one or more portions of the digital platform 107 that the one or more users interacted with as part of the one or more user sessions. The digital platform design evaluation logic 114 is also configured to determine, utilizing the digital representation of the user-perceived content, one or more design evaluation metrics for a design of the one or more portions of the digital platform 107 that the one or more users interacted with as part of the one or more user sessions. The digital platform design generation logic 116 is configured to automatically modify a configuration of at least one of the one or more portions of the digital platform 107 based at least in part on the determined one or more design evaluation metrics. The digital platform design configuration framework 110 may interact with or communicate with the client devices 102, the digital platform 107 and/or the monitoring database 108 through various host agents running on such components, or via other communication channels.

The client devices 102 may comprise, for example, physical computing devices such as mobile telephones, laptop computers, tablet computers, desktop computers, Internet of Things (IoT) devices, or other types of devices. Such devices are examples of what are more generally referred to herein as “processing devices.” Some of these processing devices are also generally referred to herein as “computers.” The client devices 102 in some cases may also or alternatively comprise virtualized computing resources, such as virtual machines (VMs), software containers, etc.

The client devices 102 may in some embodiments comprise respective computers associated with different companies, enterprises, organizations or other entities. In addition, at least portions of the system 100 may also be referred to herein as collectively comprising one or more “enterprises.” Numerous other operating scenarios involving a wide variety of different types and arrangements of processing nodes are possible, as will be appreciated by those skilled in the art.

The network 104 is assumed to comprise a global computer network such as the Internet, although other types of networks can be used, including a wide area network (WAN), a local area network (LAN), a satellite network, a telephone or cable network, a cellular network, a wireless network such as a WiFi or WiMAX network, or various portions or combinations of these and other types of networks.

The digital platform 107 running on the IT assets 106 of the IT infrastructure 105 may be associated with or operated by one or more enterprises, organizations or other entities. The IT assets 106 and the IT infrastructure 105 on which the digital platform 107 runs may therefore be referred to as an enterprise system. As used herein, the term “enterprise system” is intended to be construed broadly to include any group of systems or other computing devices. In some embodiments, an enterprise system includes cloud infrastructure comprising one or more clouds (e.g., one or more public clouds, one or more private clouds, one or more hybrid clouds, combinations thereof, etc.). The cloud infrastructure may also host at least a portion of the client devices 102. A given enterprise system may host assets that are associated with multiple enterprises (e.g., two or more different businesses, entities or other organizations). For example, in some cases the IT infrastructure 105 may host multiple different digital platforms associated with different enterprises (e.g., different vendors) which offer their products and services to users of the client devices 102. Each of such multiple digital platforms may utilize the digital platform design configuration framework 110 (or another instance thereof) for evaluation of design metrics and configuration of the digital platforms. The monitoring database 108 and/or the digital platform design configuration framework 110, although shown in FIG. 1 as being implemented external to the IT infrastructure 105, may in other embodiments be at least partially implemented using IT assets of the IT infrastructure 105 (e.g., potentially the same IT assets 106 on which the digital platform 107 runs).

The monitoring database 108, as discussed above, is configured to store and record various information that is used by the digital platform design configuration framework 110 in evaluating design constructs of the digital platform 107, and for configuring the digital platform 107 based on design metrics such as accessibility, readability and cognitive load. In some embodiments, the monitoring database 108 stores information related to user behavior on the digital platform 107, and can include information such as survey responses or other feedback related to the experience of different users on the digital platform 107, observed actions of users on the digital platform 107 (e.g., user journeys in one or more sessions), etc. The monitoring database 108 may store Hypertext Markup Language (HTML) or other data from tracked user journeys on the digital platform 107 which allow for re-creation of portions of the design of the digital platform (e.g., different pages or other portions of the digital platform 107) as perceived by the users for on-demand evaluation of design metrics such as accessibility, readability and cognitive load. The monitoring database 108 may further store one or more machine learning models (e.g., one or more generative artificial intelligence models) configured for automated generation of designs for one or more portions of the digital platform 107 using the design metrics as input.

The monitoring database 108 in some embodiments is implemented using one or more storage systems or devices associated with the digital platform design configuration framework 110. In some embodiments, one or more of the storage systems utilized to implement the monitoring database 108 comprises a scale-out all-flash content addressable storage array or other type of storage array. The term “storage system” as used herein is therefore intended to be broadly construed, and should not be viewed as being limited to content addressable storage systems or flash-based storage systems. A given storage system as the term is broadly used herein can comprise, for example, network-attached storage (NAS), storage area networks (SANs), direct-attached storage (DAS) and distributed DAS, as well as combinations of these and other storage types, including software-defined storage. Other particular types of storage products that can be used in implementing storage systems in illustrative embodiments include all-flash and hybrid flash storage arrays, software-defined storage products, cloud storage products, object-based storage products, and scale-out NAS clusters. Combinations of multiple ones of these and other storage products can also be used in implementing a given storage system in an illustrative embodiment.

Although not explicitly shown in FIG. 1, one or more input-output devices such as keyboards, displays or other types of input-output devices may be used to support one or more user interfaces to the client devices 102, the digital platform 107, the monitoring database 108 and the digital platform design configuration framework 110, as well as to support communication therebetween and with other related systems and devices not explicitly shown.

Although shown in the FIG. 1 embodiment as being separate from the client devices 102 and the digital platform 107 (e.g., as a stand-alone server, set of servers or other type of system coupled via the network 104 to the client devices 102 and the digital platform 107), the digital platform design configuration framework 110 or at least portions thereof (e.g., one or more of the digital platform design capture logic 112, the digital platform design evaluation logic 114 and the digital platform design generation logic 116) may in other embodiments be implemented at least in part internally to one or more of the client devices 102 and/or the IT infrastructure 105 (e.g., potentially on the same IT assets 106 on which the digital platform 107 runs). In some embodiments, the digital platform design configuration framework 110 is implemented as a service that the digital platform 107 (and potentially other distinct digital platforms) and/or the client devices 102 subscribe to.

The client devices 102, the digital platform 107, the IT assets 106, the monitoring database 108 and the digital platform design configuration framework 110 in the FIG. 1 embodiment are assumed to be implemented using at least one processing device. Each such processing device generally comprises at least one processor and an associated memory, and implements at least a portion of the functionality of such elements, such as one or more of the digital platform design capture logic 112, the digital platform design evaluation logic 114 and the digital platform design generation logic 116 of the digital platform design configuration framework 110.

It is to be appreciated that the particular arrangement of the client devices 102, the IT assets 106, the digital platform 107, the monitoring database 108 and the digital platform design configuration framework 110 illustrated in the FIG. 1 embodiment is presented by way of example only, and alternative arrangements can be used in other embodiments. As discussed above, for example, the digital platform design configuration framework 110 may in some cases be implemented at least in part internal to one or more of the client devices 102 and/or the IT infrastructure 105. At least portions of the digital platform design capture logic 112, the digital platform design evaluation logic 114 and the digital platform design generation logic 116 may be implemented at least in part in the form of software that is stored in memory and executed by a processor.

It is to be understood that the particular set of elements shown in FIG. 1 for automated configuration of a digital platform based on evaluation of design metrics is presented by way of illustrative example only, and in other embodiments additional or alternative elements may be used. Thus, another embodiment may include additional or alternative systems, devices and other network entities, as well as different arrangements of modules, logic and other components.

The client devices 102, the IT assets 106, the digital platform 107, the monitoring database 108 and the digital platform design configuration framework 110, as described above and in further detail below, may be part of cloud infrastructure.

The client devices 102, the IT assets 106, the digital platform 107, the monitoring database 108 and the digital platform design configuration framework 110, and other components of the information processing system 100 in the FIG. 1 embodiment are assumed to be implemented using at least one processing platform comprising one or more processing devices each having a processor coupled to a memory. Such processing devices can illustratively include particular arrangements of compute, storage and network resources. The client devices 102, the IT assets 106, the digital platform 107, the monitoring database 108 and the digital platform design configuration framework 110, or components thereof, may be implemented on respective distinct processing platforms, although numerous other arrangements are possible. For example, in some embodiments at least portions of client devices 102, the IT assets 106, the digital platform 107, the monitoring database 108 and the digital platform design configuration framework 110, or components thereof, are implemented on the same processing platform.

The term “processing platform” as used herein is intended to be broadly construed so as to encompass, by way of illustration and without limitation, multiple sets of processing devices and associated storage systems that are configured to communicate over one or more networks. For example, distributed implementations of the system 100 are possible, in which certain components of the system reside in one data center in a first geographic location while other components of the system reside in one or more other data centers in one or more other geographic locations that are potentially remote from the first geographic location. Thus, it is possible in some implementations of the system 100 for client devices 102, the IT assets 106, the digital platform 107, the monitoring database 108 and the digital platform design configuration framework 110, or portions or components thereof, to reside in different data centers. Numerous other distributed implementations are possible.

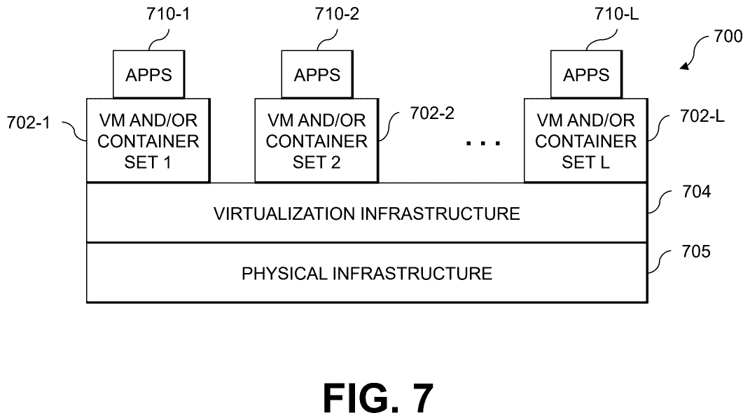

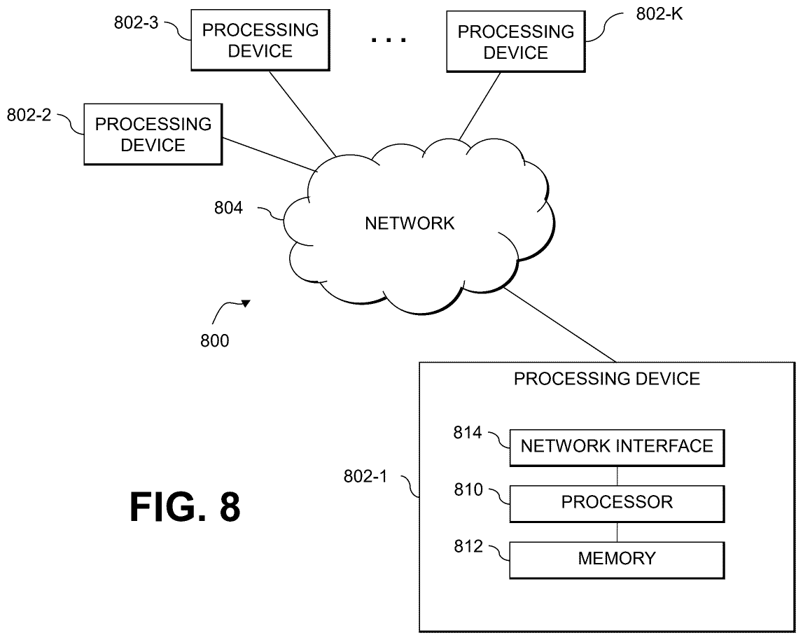

Additional examples of processing platforms utilized to implement client devices 102, the IT assets 106, the digital platform 107, the monitoring database 108 and the digital platform design configuration framework 110, and other components of the system 100 in illustrative embodiments will be described in more detail below in conjunction with FIGS. 7 and 8.

It is to be appreciated that these and other features of illustrative embodiments are presented by way of example only, and should not be construed as limiting in any way.

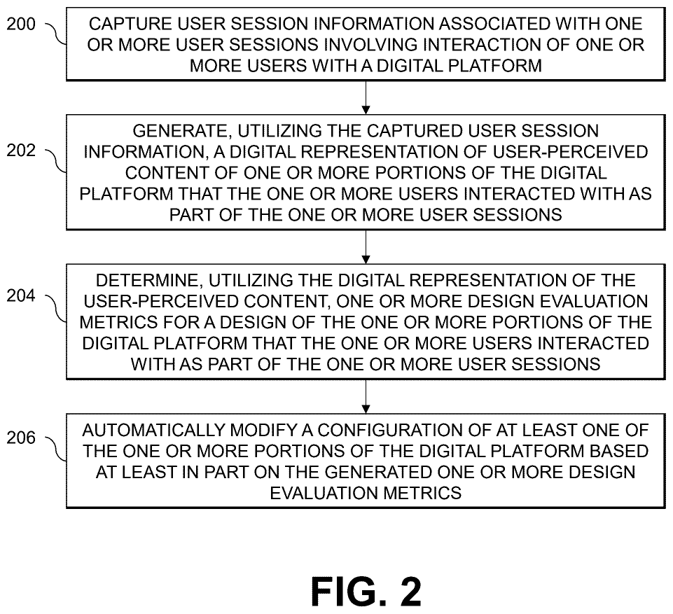

An exemplary process for automated configuration of a digital platform based on evaluation of design metrics will now be described in more detail with reference to the flow diagram of FIG. 2. It is to be understood that this particular process is only an example, and that additional or alternative processes for automated configuration of a digital platform based on evaluation of design metrics may be used in other embodiments.

In this embodiment, the process includes steps 200 through 206. These steps are assumed to be performed by the digital platform design configuration framework 110 utilizing the digital platform design capture logic 112, the digital platform design evaluation logic 114 and the digital platform design generation logic 116. The process begins with step 200, capturing user session information associated with one or more user sessions involving interaction of one or more users with a digital platform. The digital platform may include a website, a web-based interactive application, combinations thereof, etc. The captured user session information may include a specification of one or more pages of the digital platform visited by a given one of the one or more users during a given one of the one or more user sessions. In step 202, the captured user session information is utilized to generate a digital representation of user-perceived content of one or more portions of the digital platform that the one or more users interacted with as part of the one or more user sessions. The digital representation of the user-perceived content may comprise HTML data configured for use in on-demand rendering of the one or more portions of the digital platform that the one or more users interacted with as part of the one or more user sessions.

In step 204, one or more design evaluation metrics for a design of the one or more portions of the digital platform that the one or more users interacted with as part of the one or more user sessions is determined utilizing the digital representation of the user-perceived content. The determined one or more design evaluation metrics may comprise an overall design evaluation metric that is based at least in part on an accessibility design evaluation metric, a readability design evaluation metric, and a cognitive load design evaluation metric. The accessibility design evaluation metric may be determined based at least in part on rendering HTML data for the one or more portions of the digital platform, and wherein the readability design evaluation metric and the cognitive load design evaluation metric are determined based at least in part on screenshot images of the rendered HTML data for the one or more portions of the digital platform.

The accessibility design evaluation metric characterizes accessibility of the one or more portions of the digital platform, the accessibility design evaluation metric being based at least in part on one or more of: a height and width of content displayed in a given one of the one or more portions of the digital platform; a number of accessibility tests for the given portion of the digital platform which have at least one of failed and require further review; an impact severity of one or more of the accessibility tests for the given portion of the digital platform which have at least one of failed and require further review; and one or more disabilities affected by the given portion of the digital platform.

The readability design evaluation metric characterizes readability of the one or more portions of the digital platform, the readability design evaluation metric being based at least in part on one or more of: an area of content displayed in a given one of the one or more portions of the digital platform; a number of words in the content displayed in the given portion of the digital platform; a number of syllables in the content displayed in the given portion of the digital platform; and a portion of the area of the content display in the given portion of the digital platform which is covered by at least one of texts and graphics.

The cognitive load design evaluation metric characterizes cognitive load of the one or more portions of the digital platform, the cognitive load design evaluation metric being based at least in part on one or more of: a number of information clusters displayed in a given one of the one or more portions of the digital platform; a size of the information clusters displayed in the given portion of the digital platform; and a distance between the information clusters displayed in the given portion of the digital platform.

A configuration of at least one of the one or more portions of the digital platform is automatically modified in step 206 based at least in part on the generated one or more design evaluation metrics. Such automatic modification may include, for example, prompting a user to accept or approve recommended changes in the configuration of the one or more portions of the digital platform, and implementing the recommended changes responsive to user input accepting or approving the recommended changes. Step 206 may include prioritizing one or more aspects of a digital experience to deliver to different subsets of a plurality of users of the digital platform. Step 206 may also or alternatively include utilizing the determined one or more design evaluation metrics as input to one or more generative artificial intelligence models configured to generate content for said at least one of the one or more portions of the digital platform. Step 206 may further or alternatively include altering content of said at least one of the one or more portions of the digital platform to adjust at least one of an accessibility, a readability and a cognitive load of said at least one of the one or more portions of the digital platform. In some embodiments, capturing the user session information in step 200 includes capturing at least a first user session involving interaction with a first version of the digital platform in a pre-production environment and at least a second user session involving interaction with a second version of the digital platform, and modifying the configuration of said at least one of the one or more portions of the digital platform in step 206 includes selecting, based at least in part on the generated one or more design evaluation metrics, one of the first version and the second version of the digital platform to deploy to a production environment.

The particular processing operations and other system functionality described in conjunction with the flow diagram of FIG. 2 are presented by way of illustrative example only, and should not be construed as limiting the scope of the disclosure in any way. Alternative embodiments can use other types of processing operations. For example, as indicated above, the ordering of the process steps may be varied in other embodiments, or certain steps may be performed at least in part concurrently with one another rather than serially. Also, one or more of the process steps may be repeated periodically, or multiple instances of the process can be performed in parallel with one another in order to implement a plurality of different processes for different sessions, etc.

Functionality such as that described in conjunction with the flow diagram of FIG. 2 can be implemented at least in part in the form of one or more software programs stored in memory and executed by a processor of a processing device such as a computer or server. As will be described below, a memory or other storage device having executable program code of one or more software programs embodied therein is an example of what is more generally referred to herein as a “processor-readable storage medium.”

In e-commerce and other settings, entities rely on effective digital design and optimized content to communicate with their customers or other users. However, the ability to objectively measure design impact on customers or other users is a complex task that requires a multi-faceted solution. Illustrative embodiments provide technical solutions with functionality for automated capture for design constructs (ACDC) of digital platforms. The automated capture for design constructs functionality provides a unique process by which objective, user-centric quantitative design metrics are brought together along with user data to facilitate the optimization of digital experiences in digital platforms. The technical solutions provide a process wherein web pages and generated renderings (e.g., images) from a user's online journey or a designer's pre-production upload are evaluated for various design metrics such as cognitive load, accessibility and readability. The technical solutions are thus advantageously able to bring together a constellation of web page and image-based user experience metrics, at scale, which can be combined into an overall digital platform experience score. Together, the user experience metrics provide an objective measure of the quality of content and design of a digital platform as users engage with the digital platform, while also providing objective feedback and standards to designers as they iterate through the design process of a digital platform (e.g., in pre-production). This allows stakeholders to identify statistical relationships between individual elements of digital designs and user behavior, explicit feedback, and financial or other metrics. The technical solutions can be used to generate and fine-tune scalable inputs for artificial intelligence (AI)-based solutions for generating content and digital design of digital platforms.

The effectiveness of a digital design for a digital platform such as a website is typically measured by one or more financial metrics (e.g., conversion rates) and simple behavioral metrics (e.g., click-through and exit rates). The technical solutions described herein provide a scalable dataset of user-centric measures that cumulatively expand well beyond any known or entity-specific metrics. The technical solutions serve as a flexible scaffolding onto which an organization or other entity can automate its design measurements, expand its observational data surveillance, instantiate quality assurance metrics, identify patterns of content (e.g., images, words, spacing, etc.) with specific user behaviors, link experiential value to financial outcomes, and ultimately serve as a library for AI or machine learning (ML)-based generation of the content and structural design of digital platforms.

There is a need for measurement processes for design dimensions for digital platforms that can be sustainably, universally or individually calculated. Most organizations or other entities rely on the financial outcomes of user sessions on digital platforms (e.g., how much was paid when purchasing a product) to infer the quality, consumability and aesthetic perceptions of its online content. This is not optimal in various situations, such as when trying to estimate the user-specific effect of digital designs across multiple journeys (e.g., the effect of a new design for a digital platform within shop, play and learn journeys that have varying success metrics, which may be entity-centric).

At times, an entity has the ability to glean information from a few cross-sectional measures that are used to convey design effectiveness (e.g., compliance with the entity's design guidelines). However, these metrics offer only a partial understanding of how design impacts users. The current state of analytic metrics does not allow for a causal analysis of individual design features that tie to user behavior, differentiation of the content impact at the page and journey level, or the potential to inform dynamic generative design in the future. To calculate a valid, precise measure of online content of a digital platform that can map design inputs to user behavior, a more bespoke and complex approach is needed.

Conventional approaches suffer from a number of technical challenges, including that current measures do not account for the complexity of design perception, a lack of scalable measures of design impact, and stunted potential for generative AI-produced content.

The individual perception of a design of a digital platform cannot be directly observed (i.e., it is latent). Hence, the measurement of a design is more complex than observing a simple behavior such as a purchase and subsequently attributing it to the success of any design dimension (e.g., content, imagery, composition, text, etc.). Human cognition, psychology, preference, situation and task complexity all impact the perception of a design, particularly as the design impacts the performance of a task. It is therefore necessary to break down the various antecedents of behavior at the page level or the session level, so that success within each dimension of design perception can be accurately attributed to the specific design elements under investigation.

Design quality may be evaluated using a set of standards or design rules to ensure optimal delivery of elements, such as contrast between design elements, visual flow supported by repetition of forms, alignment of design elements with each other, distance between design elements, and visual message intent via balance or symmetry. The need for quick design turnover and a lack of automated checks within a designer's pre-production workflow results in suboptimal designs going into production. Integrating quantitative, multimodal design quality metrics into both pre- and post-production design workflows would allow an organization or other entity to ensure that page designs of digital platforms are optimized for all levels of human cognition.

There is a need to make these and other design measures available to stakeholders of a given entity. The availability is typically limited to isolated measures (e.g., a third-party rating of readability alone). The technical solutions provide user-centric design measures together at the page and session level for both post-production analytics and pre-production design iteration, greatly improving stakeholders' ability to effectively evaluate and optimize a user's individual ability to consume designs, as well as to set latent design benchmarks or goals across page types (e.g., optimal or improved design patterns for different pages or portions of a digital platform, such as unified product details, knowledge articles, etc.).

Almost all designs are subject to both quality assurance and user-testing before launching to production, and are also tested in production with aggregate behavioral and financial analyses (e.g., A/B testing). The capacity to gain insight on the impact a design has on a user in a real-world setting can be constrained by sample size, limited availability of financial or behavioral metrics, and limited effect size. Further, insofar as a design exists in the context of an overall journey, aggregate behavioral and financial measures lack sufficient detail to measure interaction effects that the design may have on the overall journey, especially in complex task scenarios. The timeframe of testing is also typically limited, and cannot account for the impact a design may have outside the initial testing phases. Although the context of a particular design may change (e.g., changes on pages within a shared user-journey), with conventional approaches it would be impractical to continually monitor the effect of design over long periods of time. Having consistent, reliable, scalable and objective measures of the perception of a design of a digital platform can add insight to the design testing process. Alignment between such measures and onsite behavioral data would provide an opportunity to test the impact that the design of a digital platform has on overall user journeys. The technical solutions provide infrastructure in place to automatically capture objective measures, aligned to behavioral data, on an ongoing basis to support long-term evaluation of a design and reduce the costs of manually applying and tracking individual measures.

Generative artificial intelligence (generative AI) may be used to produce content, such as at least a portion of design of a digital platform. There is a need to solidify the measures necessary to feed a content generation engine that leverages generative AI. While an entity may have a plethora of data to feed into generative AI solutions, the adage “garbage in, garbage out” neatly summarizes an entity's need for objective means of weighting, refining and fine-tuning content for optimized modeling. To solve these technical challenges, the technical solutions provide a scalable method of generating quantitative design metrics that can flexibly and accurately assess how content within an individual's online journey in a digital platform leads to behavioral and financial success.

Capturing and processing of user session and visit data on a digital platform may involve a three-phase workflow. The first phase, automated session capture, begins by capturing user session information as recorded by session replay and analytics services on an entity's websites or other digital platform, and storing that data in a database. In the second phase, perceived content storage, the stored sessions are processed by fetching the captured data in the form of HTML pages and is stored using a selected storage solution (e.g., an entity-owned storage solution). In the third phase, web page or digital platform evaluation, the stored web content (e.g., HTML or image content) is used to evaluate the user's experience. The evaluative measures include scores or metrics including an overall experience score, a cognitive load score, a readability score, and an accessibility score.

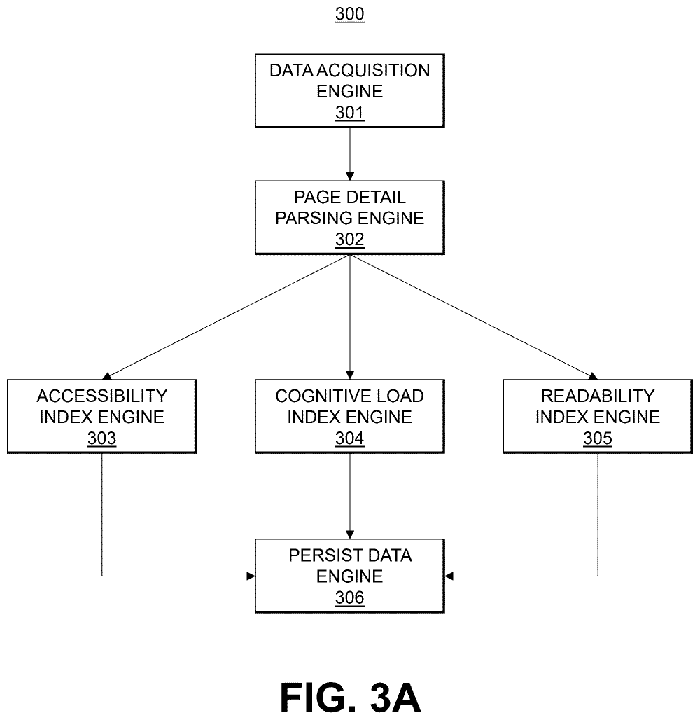

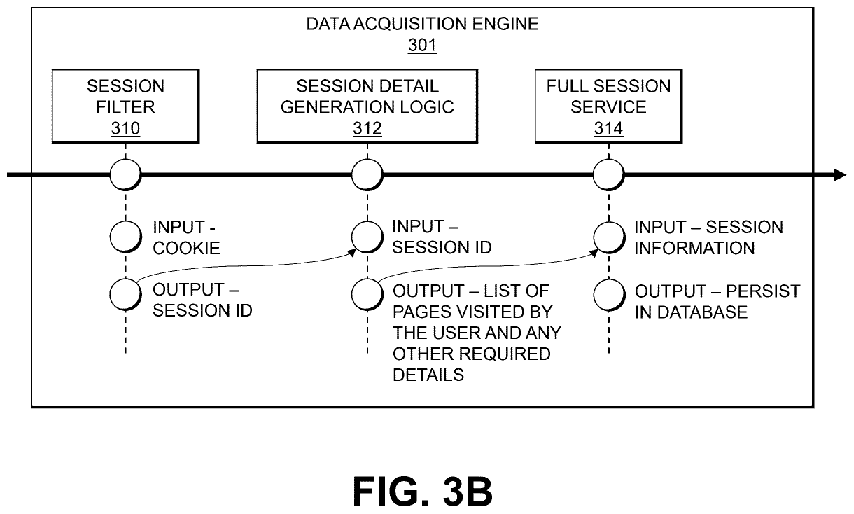

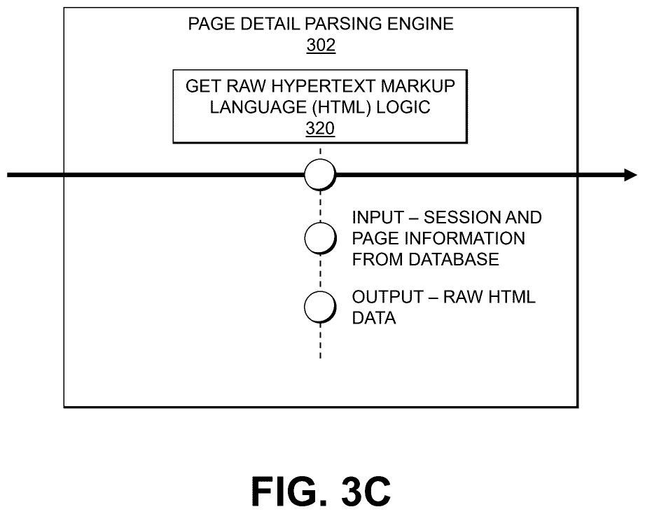

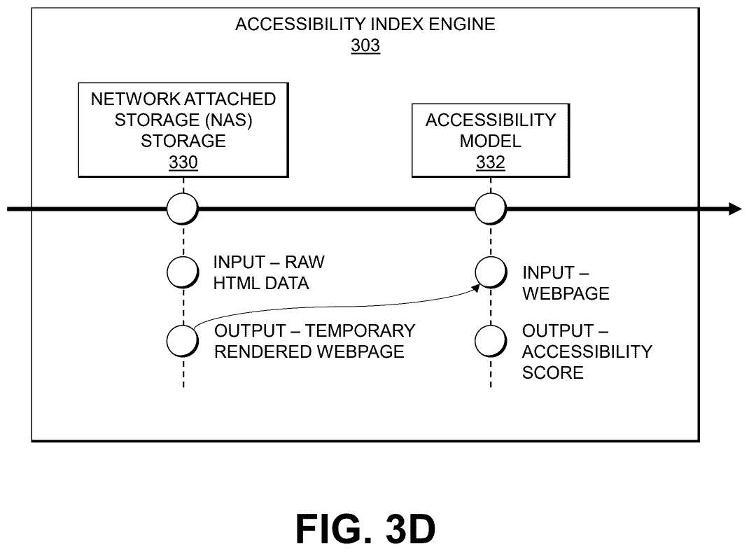

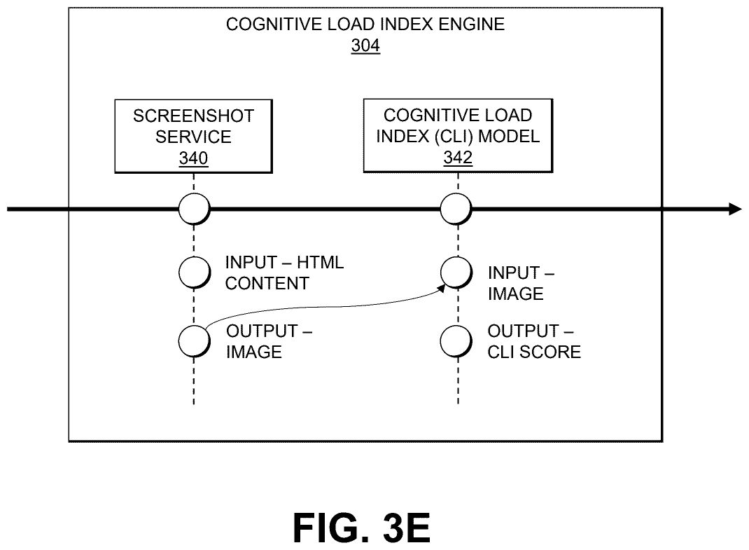

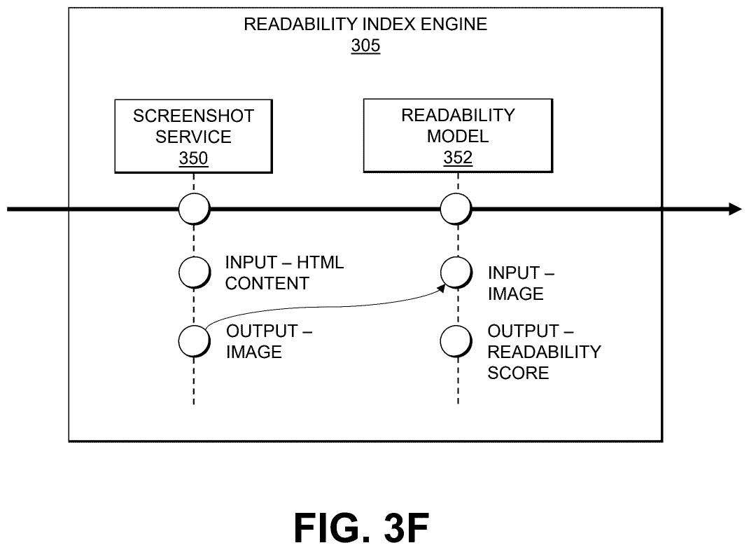

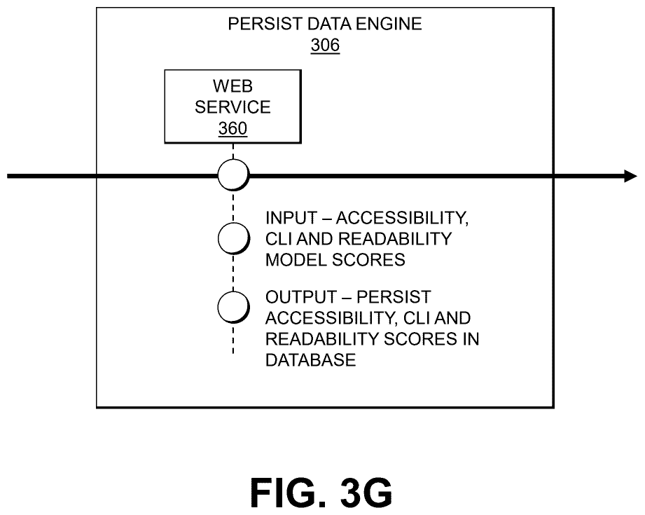

FIGS. 3A-3G show a system 300 configured for capture and processing of user session and visit data on digital platforms. As shown in FIG. 3A, the system 300 includes a data acquisition engine 301, a page detail parsing engine 302, an accessibility index engine 303, a cognitive load index engine 304, a readability index engine 305, and a persist data engine 306.

FIG. 3B shows a detailed view of the processing performed by the data acquisition engine 301. When applied or activated, the data acquisition engine 301 will capture a user experience on a digital platform (e.g., a website) through the user journey using anonymous session analytics capture and replay technologies. In some embodiments, the data acquisition engine 301 is applied or activated in response to one or more triggers, such as a user opt-in (e.g., from a survey), specific geographic regions, etc. In other embodiments, the data acquisition engine 301 is applied or activated as a global process (e.g., for all user visits to a digital platform, for user visits to one or more designated portions of a digital platform such as one or more specific web pages, etc.). As shown in FIG. 3B, the data acquisition engine 301 implements a session filter 310, session detail generation logic 312 and a full session service 314. The session filter 310 takes as input a cookie for a user journey, and outputs a session identifier (ID). The session detail generation logic 312 takes as input the session ID, and outputs a list of pages or other portions of a digital platform that are visited by a user, along with other required details (e.g., page uniform resource locators (URLs), page names, browser dimensions, geographical information, etc.). The full session service 314 takes as input the session information output by the session detail generation logic 312, and as output persists the session information in a database.

FIG. 3C shows a detailed view of the processing performed by the page detail parsing engine 302. The page detail parsing engine 302 provides perceived content storage, and is configured to extract and store the captured pages or other portions of a digital platform that are seen by a user in their journey. If the user is logged in to their account, the rendered pages will show the personalized content seen by the user during that visit. This is particularly useful for understanding how the design of web pages or other portions of a digital platform impact behavioral measures. The captured HTML pages are stored in a storage solution (e.g., an entity-owned storage solution) in an indexed manner for efficient storage and faster retrieval. The captured content can later be used for either on-demand page renders for reference, or for conversion into full-page screenshots used in generated metrics that work on image data. As shown in FIG. 3C, the page detail parsing engine 302 implements get raw HTML logic 320 which takes as input session and page information from the database, and outputs raw HTML data.

Digital platform design evaluation utilizes rendered images and/or HTML data to calculate various metrics. In the system 300, metrics are processed independently (and potentially in parallel with one another) using the accessibility index engine 303, the cognitive load index engine 304 and the readability index engine 305. While the system 300 utilizes a base digital platform design evaluation based on just three metrics (accessibility, cognitive load and readability indices), various other webpage-based or image-based metrics can be flexibly added as needed (e.g., through additional engines which operate on rendered images or HTML data produced by the page detail parsing engine 302).

FIG. 3D shows a detailed view of the processing performed by the accessibility index engine 303. Accessibility refers to making websites or other digital platforms available to everyone, including users with a diverse range of hearing, movement, sight and cognitive abilities. Accessibility removes barriers. Globally, most regulation is aligned to the Web Content Accessibility Guidelines (WCAG) version 2.1 Level AA standard. Verifying conformity to this or other accessibility standards involves both automated and manual testing. Open source automation tools include tests mapped to one or more of the success criteria related to the WCAG 2.1 AA standard. Such automation tools scan each page or other portion of a digital platform, execute the tests, and generate an overall quality score as well as a list of tests which have failed or need review, their impact and disabilities affected. With advances in technology, the ability to use automation for validation enables even greater conformity to WCAG 2.1 AA and other accessibility standards over time. Accessibility includes evaluations of touch, sight, hearing and speaking along permanent, temporary and situational dimensions. Consider, for touch, a permanent accessibility issue that includes a loss of limb (e.g., an arm), a temporary accessibility issue that includes an injury (e.g., an arm injury), or a situational accessibility issue (e.g., a new parent holding a child such that only one arm is available). For sight, a permanent accessibility issue may be blindness (or colorblindness), while a temporary accessibility issue may be cataracts and a situational accessibility issue may be a distracted driver. For hearing, a permanent accessibility issue may be deafness, while a temporary accessibility issue is an ear infection and a situational accessibility issue may be a user in a loud environment. For speech, a permanent accessibility issue may be a user that is non-verbal, a temporary accessibility issue may be a user with laryngitis, and a situational accessibility issue may be a user with a heavy accent. As shown in FIG. 3D, the accessibility index engine 303 includes Network Attached Storage (NAS) storage 330 and an accessibility model 332. The NAS storage 330 uses as input raw HTML data, and provides as output a temporary rendered webpage or other portion of a digital platform. The accessibility model 332 uses as input the temporary rendered webpage and produces as output an accessibility score.

FIG. 3E shows a detailed view of the processing performed by the cognitive load index engine 304. Since the human brain is limited in its capacity to attend to any one piece of information at one time, a Cognitive Load Index (CLI) may be used to assess the cognitive load that a user experiences when looking at any given design or webpage. CLI is an automated, quantitative metric created to objectively quantify the density of information displayed on a screen, which is intended to help evaluate and optimize designs. The CLI may be a composite score that considers multiple spatial clustering metrics including the number of information clusters, the spacing between them, the size of the information clusters, etc. ACDC functionality has the ability to capture both CLI and its constituent measures, which will allow users to investigate behavioral relationships at each level across user journeys. For example, a composite CLI score may provide an easily interpreted numerical value for designers iterating on designs with as-a-service features of ACDC. One or more of the individual information cluster metrics (e.g., the number of information clusters, the information cluster spacing, the size of the information clusters, etc.) may stand out as a strong predictor of customer satisfaction (CSAT) or Exit Rate behavior at the site or digital platform level. As shown in FIG. 3E, the cognitive load index engine 304 includes a screenshot service 340 and a CLI model 342. The screenshot service 340 uses as input HTML content and outputs an image representing the HTML content. The CLI model 342 uses as input the image representing the HTML content and outputs a CLI score for the image.

FIG. 3F shows a detailed view of the processing performed by the readability index engine 305. Readability is a measure of case in consuming a block of text (e.g., on a web page or other portion of a digital platform). The readability measure used in some embodiments is based on the density of on-page words and graphics (e.g., the ratio of pixels covered by graphics and text to the total page size), as well as the number of on-page words. Automated tools or scripts may be used to calculate the text and graphics coverage of a web page or other portion of a digital platform, and for measuring the readability of web pages. As shown in FIG. 3F, the readability index engine 305 includes a screenshot service 350 and a readability model 352. The screenshot service 350 uses as input HTML content and outputs an image representing the HTML content. The readability model 352 uses as input the image representing the HTML content and outputs a readability score for the image.

FIG. 3G shows a detailed view of the processing performed by the persist data engine 306. The persist data engine 306 includes a web service 360 (e.g., a Webslinger service) that uses as input the accessibility score generated by the accessibility index engine 303, the CLI score generated by the cognitive load index engine 304, and the readability score generated by the readability index engine 305 to produce an output that includes an overall score for the website or other digital platform. The persist data engine 306 is also configured to persist the accessibility, CLI and readability scores in a database.

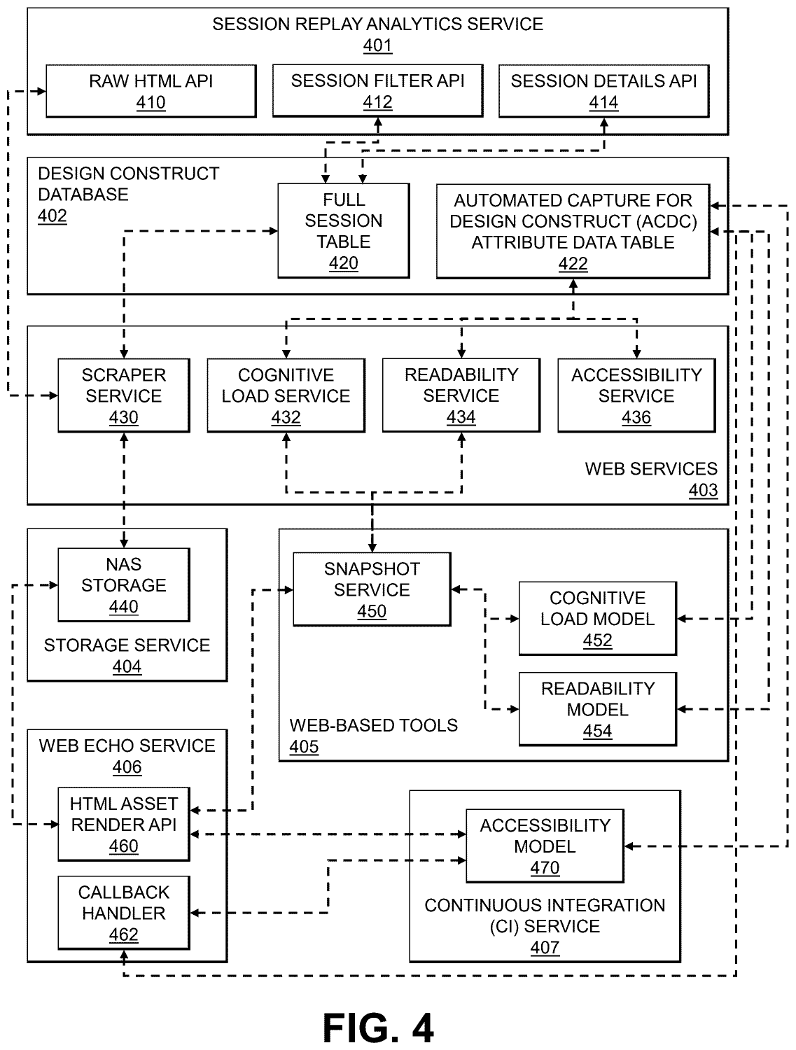

FIG. 4 shows an example architecture 400 of services, dependencies and data flow paths for an implementation of the system 300. The architecture 400 includes a session replay analytics service 401, a design construct database 402, web services 403, a storage service 404, web-based tools 405, a web echo service 406, and a continuous integration (CI) service 407 (which may be part of a continuous integration/continuous deployment (CI/CD) service or tool). The session replay analytics service 401 may be implemented on vendor or entity resources, and the design construct database 402 is implemented using one or more database servers (e.g., SQL servers). The web services 403 and web echo service 406 may be implemented using cloud resources (e.g., Pivot Cloud Foundry (PCF) services). In some embodiments, the web services 403 are implemented using Webslinger while the web echo service 406 is implemented using Webecho. The storage service 404 may be implemented using various storage assets, including entity-owned storage assets. The web-based tools 405 may be implemented using containers (e.g., Docker containers) that are homegrown or developed by the entity. The CI service 407 may be implemented using Gitlab runner or other suitable CI/CD platform tools.

The session replay analytics service 401 includes a raw HTML application programming interface (API) 410, a session filter API 412 and a session details API 414, and the design construct database 402 includes a full session table 420 and an ACDC attribute data table 422. The web services 403 include a scraper service 430, a cognitive load service 432, a readability service 434 and an accessibility service 436. The storage service 404 includes NAS storage 440, and the web-based tools include a snapshot service 450, a cognitive load model 452 and a readability model 454. The web echo service 406 includes an HTML asset render API 460 and a callback handler 462, and the CI service 407 includes an accessibility model 470. The session filter API 412 and the session details API 414 of the session replay analytics service 401 may be used to gather session information (e.g., for user sessions involving use of a digital platform of an entity) for storage in the full session table 420. The scraper service 430 utilizes the raw HTML API 410 of the session replay analytics service 401 and the information from the full session table 420 to store relevant data in the NAS storage 440. The cognitive load service 432 and readability service 434 utilizes the snapshot service 450 and information from the ACDC attribute data table 422 in order to generate images (e.g., of web pages or other portions of a digital platform) which are used by the cognitive load model 452 and the readability model 454 to produce CLI and readability metrics. The snapshot service 450 may utilize the HTML asset render API 460 to generate the images from HTML data stored in the NAS storage 440. The accessibility model 470 utilizes the HTML asset render API 460 to obtain HTML data from the NAS storage 440, and utilizes the callback handler 462 to generate accessibility metrics persisted in the ACDC attribute data table 422.

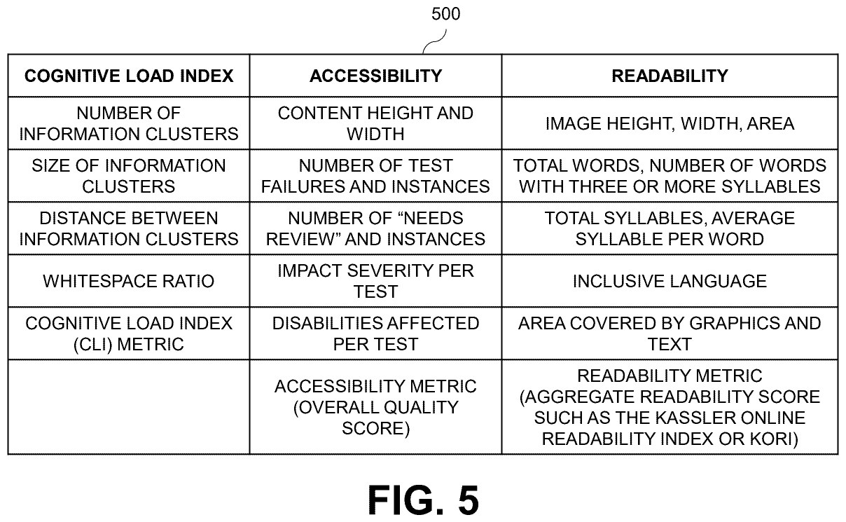

FIG. 5 shows a table 500 summarizing metrics which may be computed by the accessibility index engine 303/the accessibility service 436, the cognitive load index engine 304/the cognitive load service 432 and the readability index engine 305/the readability service 434 and which may be persisted in the ACDC attribute data table 422.

Subscription-based third-party applications such as Acrolinx and Readable may be used for analyzing content. In addition, research methods such as A/B testing, usability testing, etc. may be employed to establish the effectiveness of new or altered designs. Such applications and research methods, however, typically do not offer enough resolution to fully attribute changes in user behavior to individual design elements, nor do they provide a site-level standard. In addition to design feedback, the technical solutions described herein can be built out to replace various third-party applications to save significant resources and complexity. The technical solutions further allow for a long-term outlook on in-production designs, and promote increased design usability across all user types which can have a direct impact on financials through improved experiential (e.g., fewer exit rates, higher CSAT) and long-term metrics (e.g., repurchase behavior, site revisits, etc.). The technical solutions also provide savings indirectly by avoiding opportunity costs associated with launching of suboptimal designs and avoiding other, more time-consuming methods of design testing. Through supporting the design process during iteration, the number of iterations can be reduced which increases efficiency. The technical solutions further increase design resilience and hold the potential to solve unanticipated problems earlier on in the design process. The potential for scanning pages or other portions of a digital platform for accessibility compliance can also mitigate legal risk along the design pipeline representing additional return on investment (ROI).

The technical solutions described herein are advantageously able to capture latent perceptions of design, to generate new metrics linked to user behavioral data, and to utilize inferential learnings to drive design predictions and AI content.

Since individual design perception is latent, it is inherently difficult to objectively measure a user's ability to successfully perceive, interact with, and cognitively process a visual design. This limits the ability to evaluate whether a design of a digital platform promotes effective communication with users. By bringing together automated measures of readability, cognitive load and accessibility, the technical solutions are able to provide stakeholders with quantitative metrics of how easy or difficult a design is or will be for users to perceive. Each metric, in turn, may be composed of component measures including the number and size of information clusters, number of words, number of difficult words, text-to-graphics ratio, etc., which are relevant both early and late in a digital platform design workflow. In production stages (both pre- and post-production), these measures can be aligned with relevant guidelines (e.g., WCAG guidelines) to provide multi-factored automated feedback that may align with specific dimensions of design. The technical solutions can thus provide an efficient, as-a-service tool for supporting design iteration throughout a design workflow.

Readability, CLI and accessibility are all objective metrics relating to the perception of content (e.g., design of a digital platform). By capturing session data as well as associated warm-state HTML and screenshots, and aligning such data through APIs with readability, CLI and accessibility measures, the technical solutions described herein enable quantification of the impact of design of a digital platform on user experience (e.g., at page and session levels). User experience indicators can include expressions of affect through explicit feedback mechanisms (e.g., VoCaaS), implicit indicators expressed through behavior and pathing (e.g., rage-clicking, pathing efficiency, etc.), and can also extend to site success metrics. Because ACDC functionality in some embodiments can capture full session data, models derived from ACDC data can enable inference of design impact for a full user journey and, therefore, can be stratified against journey types (e.g., transactional, research, etc.). With automated measures of individual design elements, the technical solutions described herein provide analytical opportunities pre- and post-launch. Furthermore, the technical solutions described herein allow for flexible additions of design metrics in the future. Understanding the dimensions across which a design is more or less successful provides insight to support design iteration by informing designers, through objective measures, which factors (e.g., wording, layout, etc.) are implicit in the design's success. Further, the technical solutions provide automated processes which support the analysis of long-term impact of a design of a digital platform. As tasks and user preferences change over time, the utility and affect associated with a particular design may change. By maintaining objective measures of a design and aligning it with user experience indicators, the ACDC data infrastructure enables identification of the design factors complicit in shifts in utility and affect that, in turn, could inform design iteration and development.

The technical solutions described herein can advantageously optimize or improve inputs to generative AI or other machine learning models by offering standardized, scalable measures of accessibility (including inclusive language), readability and cognitive load for all web pages or other portions of a digital platform in a user's visit or session, while also allowing for the flexible incorporation of additional design and behavioral measures in the future. The quantitative measures brought together in the technical solutions described herein offer an objective means of weighting and refining inputs, which substantially improves the potential for generating content that truly optimizes or improves the user experience. Further, parameter tuning can be optimized or improved by quantifying the statistical relationships between the content to which a user is exposed and the behavior the user exhibits. That is, for different audiences, preferences, needs or tasks, the design with the highest probability of user suitability could be generated. The individual outputs provided by the technical solutions described herein may be used as inputs for a framework that can measure and predict user loyalty.

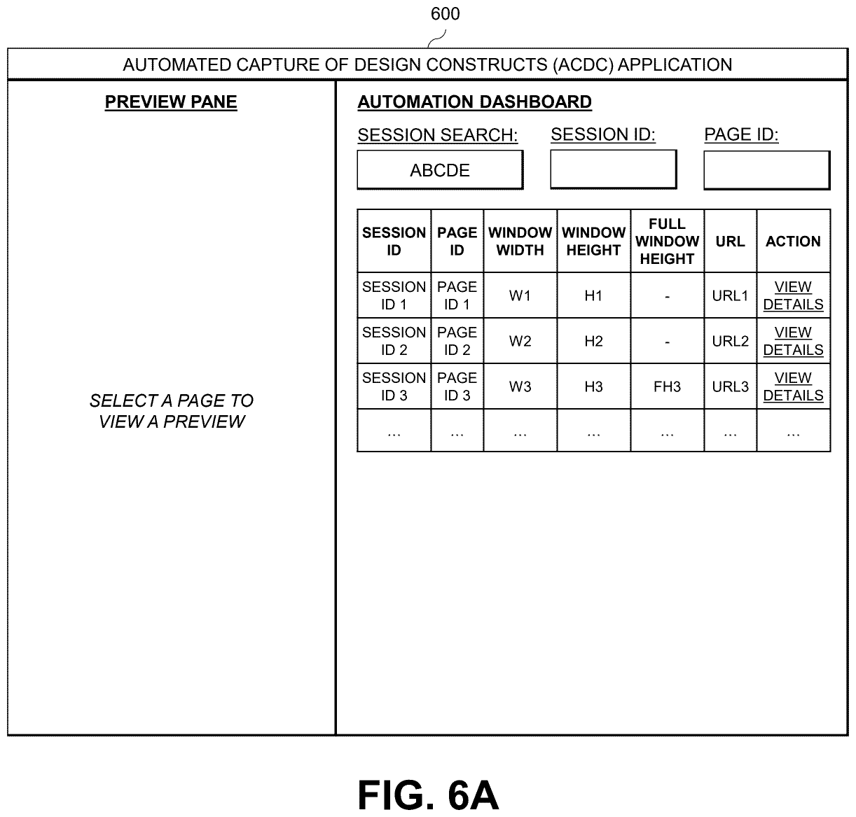

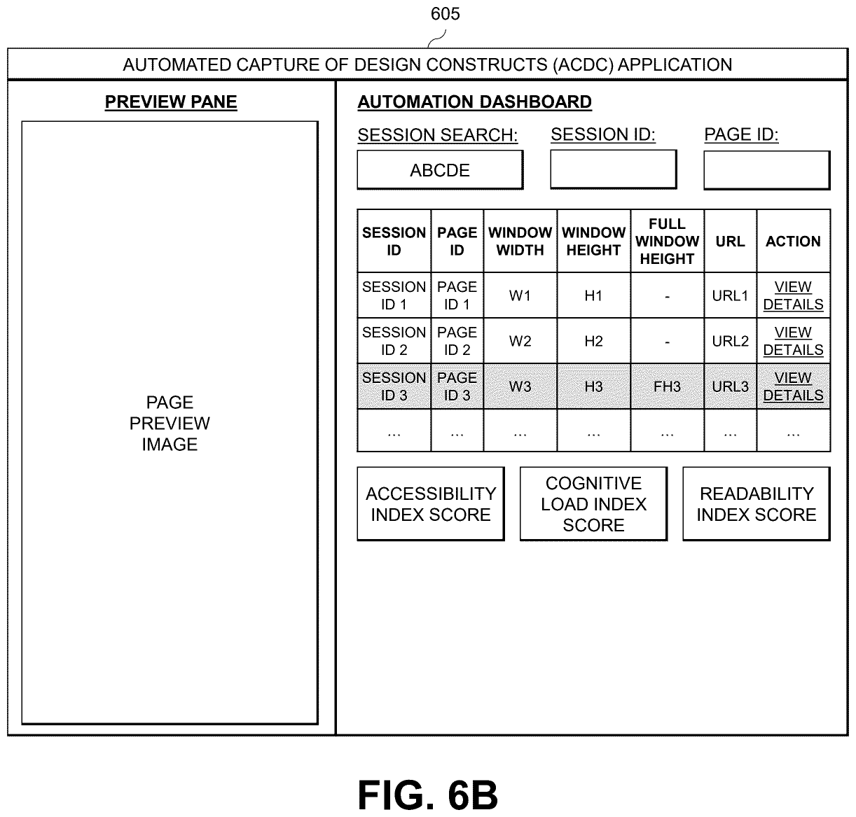

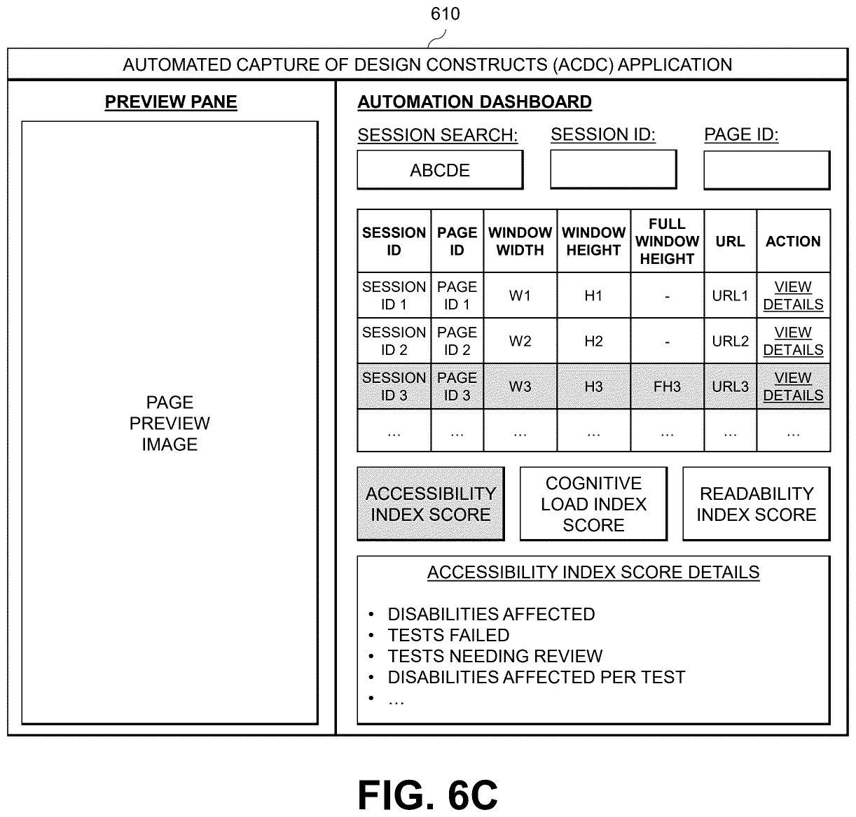

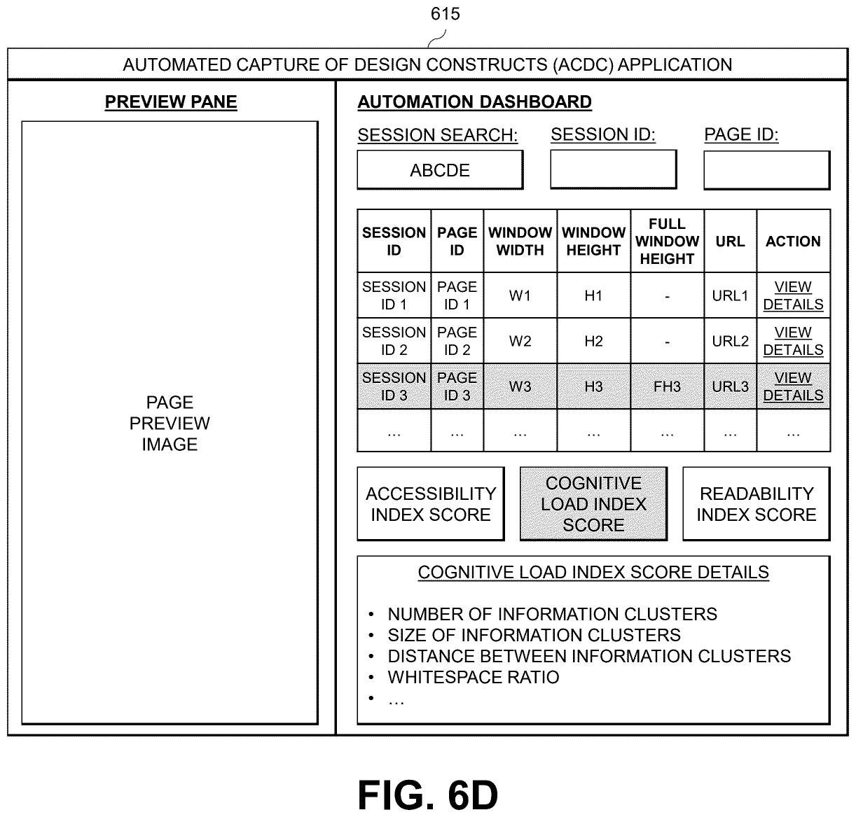

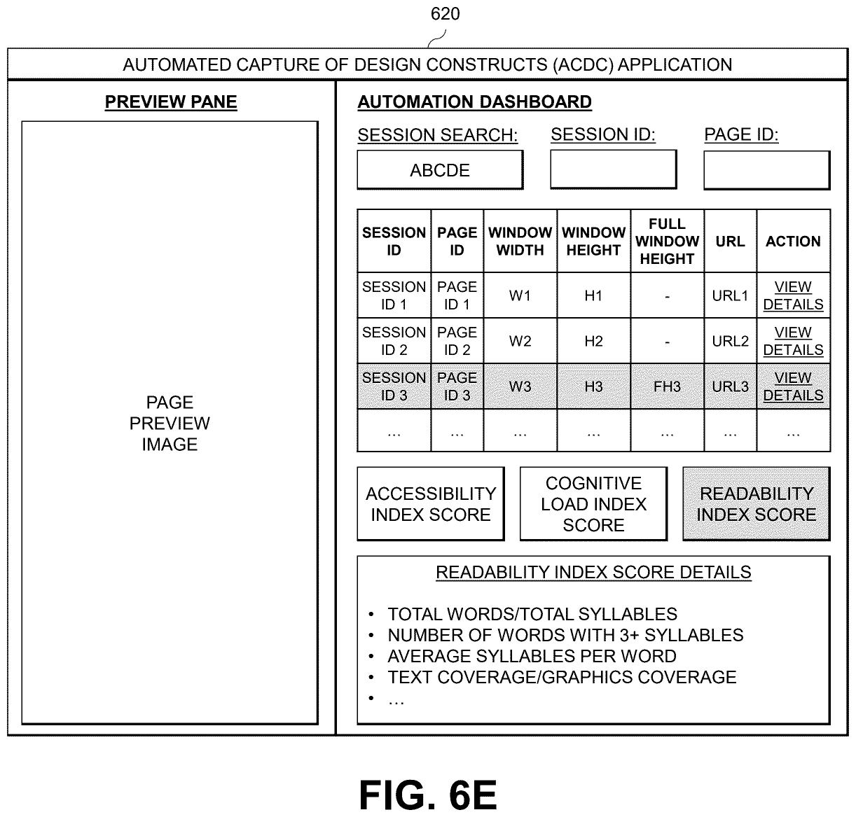

An example implementation of an ACDC application will now be described with respect to FIGS. 6A-6E. In this example implementation, VoCaaS micro-feedback survey responses by users trigger data capture for that user's session experience. FIG. 6A shows a view 600 of an ACDC application, which includes an automation dashboard allows a stakeholder to look up any individual session (e.g., by text search, session ID, page ID, etc.). Once the information is entered, the automation dashboard displays all of the pages visited within that user's journey that match the search criteria. It is then possible to double-click into the details of a page visit, as shown in the view 605 of FIG. 6B, where a preview pane of the ACDC application is populated with a preview of the selected page. The preview, in some embodiments, includes a personally identifiable information (PII)-free rendering of the selected page along with the associated design metrics for available indices (e.g., accessibility, cognitive load, and readability) for the selected page. Within this page view, it is possible to select each of the indices for further metrics and information. FIG. 6C shows a view 610 with details for the accessibility metric, FIG. 6D shows a view 615 with details for the cognitive load metric, and FIG. 6E shows a view 620 with details for the readability metric. Each of the dashboards may include selectable user interface features which allow for display of more detailed information, such as information related to component metrics which contribute to the accessibility, cognitive load and readability metrics, including cognitive load heatmaps, accessibility test failure details, etc.

In the automated session capture phase, the process starts by filtering customer sessions to ensure that the target user population is included in the analyses. Each visit to a digital platform (e.g., an entity's website) may be marked with a session cookie that is stored on the client browser. In the example implementation of FIGS. 6A-6E, the sessions that have submitted a feedback survey during the length of their visit are targeted, though the technical solutions described herein may scale to target all user visits if desired. Since the session is captured after the users submit the survey, the automated session capture begins after the survey is received. Using the session cookies, one or more sub-sessions are fetched (e.g., using session IDs) under the mentioned session which may further contain one or more pages that the user has visited during their entire experience. The visit information of the user (e.g., session and page information) is then stored in the database, which will be used to get the HTML content of the pages and other necessary details such as page URLs, page names, browser dimensions, geographical information, etc. The collected information, in some embodiments, is non-PII and any PII information in the HTML content may be masked before capture in accordance with specified privacy requirements.

In the perceived content storage phase, the captured web content or HTML content is stored in the entity-owned storage solutions such as NAS storage. The captured web content is often described as “warm state” capture. These are sessions where the user is logged in and is perceiving personalized content. If any PII is present on the page, it may be masked before any further processing and long-term storage. There may also be sessions where a user is not signed in, and where the web page that is perceived will be identical for different users (though there may be differences in presentation based on the browser used, the size or resolutions of the user's display screen, etc.).

In the web page evaluation phase, a centralized orchestrator runs multiple scheduled jobs that process the pages in the queue for their respective metrics (e.g., accessibility, cognitive load, readability, etc.). These jobs may run in parallel, and may be invoked periodically (e.g., multiple times a day). Any model that requires a URL to process is provided with the storage location of the HTML content.

It is to be appreciated that the particular advantages described above and elsewhere herein are associated with particular illustrative embodiments and need not be present in other embodiments. Also, the particular types of information processing system features and functionality as illustrated in the drawings and described above are exemplary only, and numerous other arrangements may be used in other embodiments.

Illustrative embodiments of processing platforms utilized to implement functionality for automated configuration of a digital platform based on evaluation of design metrics will now be described in greater detail with reference to FIGS. 7 and 8. Although described in the context of system 100, these platforms may also be used to implement at least portions of other information processing systems in other embodiments.

FIG. 7 shows an example processing platform comprising cloud infrastructure 700. The cloud infrastructure 700 comprises a combination of physical and virtual processing resources that may be utilized to implement at least a portion of the information processing system 100 in FIG. 1. The cloud infrastructure 700 comprises multiple VMs and/or container sets 702-1, 702-2, . . . 702-L implemented using virtualization infrastructure 704. The virtualization infrastructure 704 runs on physical infrastructure 705, and illustratively comprises one or more hypervisors and/or operating system level virtualization infrastructure. The operating system level virtualization infrastructure illustratively comprises kernel control groups of a Linux operating system or other type of operating system.

The cloud infrastructure 700 further comprises sets of applications 710-1, 710-2, . . . 710-L running on respective ones of the VMs/container sets 702-1, 702-2, . . . 702-L under the control of the virtualization infrastructure 704. The VMs/container sets 702 may comprise respective VMs, respective sets of one or more containers, or respective sets of one or more containers running in VMs.

In some implementations of the FIG. 7 embodiment, the VMs/container sets 702 comprise respective VMs implemented using virtualization infrastructure 704 that comprises at least one hypervisor. A hypervisor platform may be used to implement a hypervisor within the virtualization infrastructure 704, where the hypervisor platform has an associated virtual infrastructure management system. The underlying physical machines may comprise one or more distributed processing platforms that include one or more storage systems.

In other implementations of the FIG. 7 embodiment, the VMs/container sets 702 comprise respective containers implemented using virtualization infrastructure 704 that provides operating system level virtualization functionality, such as support for Docker containers running on bare metal hosts, or Docker containers running on VMs. The containers are illustratively implemented using respective kernel control groups of the operating system.

As is apparent from the above, one or more of the processing modules or other components of system 100 may each run on a computer, server, storage device or other processing platform element. A given such element may be viewed as an example of what is more generally referred to herein as a “processing device.” The cloud infrastructure 700 shown in FIG. 7 may represent at least a portion of one processing platform. Another example of such a processing platform is processing platform 800 shown in FIG. 8.

The processing platform 800 in this embodiment comprises a portion of system 100 and includes a plurality of processing devices, denoted 802-1, 802-2, 802-3, . . . 802-K, which communicate with one another over a network 804.

The network 804 may comprise any type of network, including by way of example a global computer network such as the Internet, a WAN, a LAN, a satellite network, a telephone or cable network, a cellular network, a wireless network such as a WiFi or WiMAX network, or various portions or combinations of these and other types of networks.

The processing device 802-1 in the processing platform 800 comprises a processor 810 coupled to a memory 812.

The processor 810 may comprise a microprocessor, a microcontroller, an application-specific integrated circuit (ASIC), a field-programmable gate array (FPGA), a central processing unit (CPU), a graphical processing unit (GPU), a tensor processing unit (TPU), a video processing unit (VPU) or other type of processing circuitry, as well as portions or combinations of such circuitry elements.

The memory 812 may comprise random access memory (RAM), read-only memory (ROM), flash memory or other types of memory, in any combination. The memory 812 and other memories disclosed herein should be viewed as illustrative examples of what are more generally referred to as “processor-readable storage media” storing executable program code of one or more software programs.

Articles of manufacture comprising such processor-readable storage media are considered illustrative embodiments. A given such article of manufacture may comprise, for example, a storage array, a storage disk or an integrated circuit containing RAM, ROM, flash memory or other electronic memory, or any of a wide variety of other types of computer program products. The term “article of manufacture” as used herein should be understood to exclude transitory, propagating signals. Numerous other types of computer program products comprising processor-readable storage media can be used.

Also included in the processing device 802-1 is network interface circuitry 814, which is used to interface the processing device with the network 804 and other system components, and may comprise conventional transceivers.

The other processing devices 802 of the processing platform 800 are assumed to be configured in a manner similar to that shown for processing device 802-1 in the figure.

Again, the particular processing platform 800 shown in the figure is presented by way of example only, and system 100 may include additional or alternative processing platforms, as well as numerous distinct processing platforms in any combination, with each such platform comprising one or more computers, servers, storage devices or other processing devices.

For example, other processing platforms used to implement illustrative embodiments can comprise converged infrastructure.

It should therefore be understood that in other embodiments different arrangements of additional or alternative elements may be used. At least a subset of these elements may be collectively implemented on a common processing platform, or each such element may be implemented on a separate processing platform.

As indicated previously, components of an information processing system as disclosed herein can be implemented at least in part in the form of one or more software programs stored in memory and executed by a processor of a processing device. For example, at least portions of the functionality for automated configuration of a digital platform based on evaluation of design metrics as disclosed herein are illustratively implemented in the form of software running on one or more processing devices.

It should again be emphasized that the above-described embodiments are presented for purposes of illustration only. Many variations and other alternative embodiments may be used. For example, the disclosed techniques are applicable to a wide variety of other types of information processing systems, designs, design personalization, etc. Also, the particular configurations of system and device elements and associated processing operations illustratively shown in the drawings can be varied in other embodiments. Moreover, the various assumptions made above in the course of describing the illustrative embodiments should also be viewed as exemplary rather than as requirements or limitations of the disclosure. Numerous other alternative embodiments within the scope of the appended claims will be readily apparent to those skilled in the art.

What is claimed is:

1. An apparatus comprising:
at least one processing device comprising a processor coupled to a memory;
the at least one processing device being configured:
to capture user session information associated with one or more user sessions involving interaction of one or more users with a digital platform;
to generate, utilizing the captured user session information, a digital representation of user-perceived content of one or more portions of the digital platform that the one or more users interacted with as part of the one or more user sessions;
to determine, utilizing the digital representation of the user-perceived content, one or more design evaluation metrics for a design of the one or more portions of the digital platform that the one or more users interacted with as part of the one or more user sessions; and
to automatically modify a configuration of at least one of the one or more portions of the digital platform based at least in part on the determined one or more design evaluation metrics.

2. The apparatus of claim 1 wherein the digital platform comprises at least one of a website and a web-based interactive application.

3. The apparatus of claim 2 wherein the captured user session information comprises a specification of one or more pages of the digital platform visited by a given one of the one or more users during a given one of the one or more user sessions.

4. The apparatus of claim 1 wherein the digital representation of the user-perceived content comprises Hypertext Markup Language (HTML) data configured for use in on-demand rendering of the one or more portions of the digital platform that the one or more users interacted with as part of the one or more user sessions.

5. The apparatus of claim 1 wherein the determined one or more design evaluation metrics comprise an accessibility design evaluation metric characterizing accessibility of the one or more portions of the digital platform, the accessibility design evaluation metric being based at least in part on one or more of:
a height and width of content displayed in a given one of the one or more portions of the digital platform;
a number of accessibility tests for the given portion of the digital platform which have at least one of failed and require further review;
an impact severity of one or more of the accessibility tests for the given portion of the digital platform which have at least one of failed and require further review; and
one or more disabilities affected by the given portion of the digital platform.

6. The apparatus of claim 1 wherein the determined one or more design evaluation metrics comprise a readability design evaluation metric characterizing readability of the one or more portions of the digital platform, the readability design evaluation metric being based at least in part on one or more of:
an area of content displayed in a given one of the one or more portions of the digital platform;
a number of words in the content displayed in the given portion of the digital platform;
a number of syllables in the content displayed in the given portion of the digital platform; and
a portion of the area of the content display in the given portion of the digital platform which is covered by at least one of texts and graphics.

7. The apparatus of claim 1 wherein the determined one or more design evaluation metrics comprise a cognitive load design evaluation metric characterizing cognitive load of the one or more portions of the digital platform, the cognitive load design evaluation metric being based at least in part on one or more of:
a number of information clusters displayed in a given one of the one or more portions of the digital platform;
a size of the information clusters displayed in the given portion of the digital platform; and
a distance between the information clusters displayed in the given portion of the digital platform.

8. The apparatus of claim 1 wherein the determined one or more design evaluation metrics comprises an overall design evaluation metric that is based at least in part on an accessibility design evaluation metric, a readability design evaluation metric, and a cognitive load design evaluation metric.

9. The apparatus of claim 8 wherein the accessibility design evaluation metric is determined based at least in part on rendering Hypertext Markup Language (HTML) data for the one or more portions of the digital platform, and wherein the readability design evaluation metric and the cognitive load design evaluation metric are determined based at least in part on screenshot images of the rendered HTML data for the one or more portions of the digital platform.

10. The apparatus of claim 1 wherein automatically modifying the configuration of at least one of the one or more portions of the digital platform based at least in part on the determined one or more design evaluation metrics comprises prioritizing one or more aspects of a digital experience to deliver to different subsets of a plurality of users of the digital platform.

11. The apparatus of claim 1 wherein automatically modifying the configuration of at least one of the one or more portions of the digital platform based at least in part on the determined one or more design evaluation metrics comprises utilizing the determined one or more design evaluation metrics as input to one or more generative artificial intelligence models configured to generate content for said at least one of the one or more portions of the digital platform.

12. The apparatus of claim 1 wherein automatically modifying the configuration of at least one of the one or more portions of the digital platform based at least in part on the determined one or more design evaluation metrics comprises altering content of said at least one of the one or more portions of the digital platform to adjust at least one of an accessibility, a readability and a cognitive load of said at least one of the one or more portions of the digital platform.

13. The apparatus of claim 1 wherein capturing the user session information comprises capturing at least a first user session involving interaction with a first version of the digital platform in a pre-production environment and at least a second user session involving interaction with a second version of the digital platform.

14. The apparatus of claim 13 wherein automatically modifying the configuration of said at least one of the one or more portions of the digital platform comprises selecting, based at least in part on the determined one or more design evaluation metrics, one of the first version and the second version of the digital platform to deploy to a production environment.

15. A computer program product comprising a non-transitory processor-readable storage medium having stored therein program code of one or more software programs, wherein the program code when executed by at least one processing device causes the at least one processing device:
to capture user session information associated with one or more user sessions involving interaction of one or more users with a digital platform;
to generate, utilizing the captured user session information, a digital representation of user-perceived content of one or more portions of the digital platform that the one or more users interacted with as part of the one or more user sessions;
to determine, utilizing the digital representation of the user-perceived content, one or more design evaluation metrics for a design of the one or more portions of the digital platform that the one or more users interacted with as part of the one or more user sessions; and
to automatically modify a configuration of at least one of the one or more portions of the digital platform based at least in part on the determined one or more design evaluation metrics.

16. The computer program product of claim 15 wherein the determined one or more design evaluation metrics comprises an overall design evaluation metric that is based at least in part on an accessibility design evaluation metric, a readability design evaluation metric, and a cognitive load design evaluation metric.

17. The computer program product of claim 15 wherein automatically modifying the configuration of at least one of the one or more portions of the digital platform based at least in part on the determined one or more design evaluation metrics comprises altering content of said at least one of the one or more portions of the digital platform to adjust at least one of an accessibility, a readability and a cognitive load of said at least one of the one or more portions of the digital platform.

18. A method comprising:
capturing user session information associated with one or more user sessions involving interaction of one or more users with a digital platform;
generating, utilizing the captured user session information, a digital representation of user-perceived content of one or more portions of the digital platform that the one or more users interacted with as part of the one or more user sessions;
determining, utilizing the digital representation of the user-perceived content, one or more design evaluation metrics for a design of the one or more portions of the digital platform that the one or more users interacted with as part of the one or more user sessions; and
automatically modifying a configuration of at least one of the one or more portions of the digital platform based at least in part on the determined one or more design evaluation metrics;
wherein the method is performed by at least one processing device comprising a processor coupled to a memory.

19. The method of claim 18 wherein the determined one or more design evaluation metrics comprises an overall design evaluation metric that is based at least in part on an accessibility design evaluation metric, a readability design evaluation metric, and a cognitive load design evaluation metric.

20. The method of claim 18 wherein automatically modifying the configuration of at least one of the one or more portions of the digital platform based at least in part on the determined one or more design evaluation metrics comprises altering content of said at least one of the one or more portions of the digital platform to adjust at least one of an accessibility, a readability and a cognitive load of said at least one of the one or more portions of the digital platform.
